(19) United States
(12) Patent Application Publication
(10) Pub. No.: US 2026/0322493 A1
(43) Pub. Date: Oct. 15, 2026

(54) Optical Equalization of Communication Networks

(71) Applicant: NEWPHOTONICS LTD., Kfar Mordechai (IL)

(72) Inventors: Yosef Ben-Ezra, Petah Tikva (IL); Timor Leiderman, Tel Aviv-Yafo (IL); Yaniv Ben-Haim, Kfar-Mordehai (IL)

(21) Appl. No.: 19/486,065

(22) PCT Filed: Mar. 27, 2024
(86) PCT No.: PCT/IL2024/050313

§ 371 Date: Nov. 20, 2025

Related U.S. Application Data
(60) Provisional application No. 63/508,037, filed on Jun. 14, 2023.

(51) Int. Cl. H04B 10/2507

(52) U.S. Cl. CPC H04B 10/2507

(57) ABSTRACT

A method and apparatus for improving transmission in an optical communication system, the method comprising: receiving an optical signal; using an optical equalization filter, equalizing the optical signal to obtain an equalized optical signal; converting the equalized optical signal to an electrical signal; comparing the electrical signal to an expected electrical signal to obtain a comparison result; based on the comparison result, determining one or more optical parameters to be modified for the optical equalization filter; based on the optical parameters to be modified, determining a modification to be applied to the optical equalization filter; and applying the modification to the optical equalization filter, thereby determining in an electrical domain distortions to the optical signal, and applying the changes in an optical domain for correcting distortions introduced to the optical signal.

### CROSS-REFERENCE TO RELATED APPLICATIONS

The present application claims priority from U.S. Provisional Patent Application Ser. No. 63/508,037, filed Jun. 14, 2023, entitled “OPTICAL EQUALIZATION OF COMMUNICATION NETWORKS” which is incorporated herein by reference.

### TECHNICAL FIELD

The present disclosure relates to optical communication networks in general, and to optical equalization in high-speed communication systems, in particular.

### BACKGROUND

Optical networks, also referred to as fiber-optic communication networks, are used for transmitting information from one place to another by sending pulses of light through an optical fiber. The light is a form of carrier wave that is modulated to carry information. Fiber is advantageous over electrical cabling when high bandwidth, long distance, or immunity to electromagnetic interference are required. This type of communication can transmit voice, video, or any other type of data through local area networks or across long distances.

However, the optical channel is not free of noise, losses, bandwidth limitations, non-linearities, dispersion, or the like, resulting in distortions of the transmitted signals. In order to compensate for the distortions, equalization may be performed, which is aimed at reversing the distortion, such that when a channel has been equalized the frequency domain attributes of the signal at the input are faithfully reproduced at the output.

Equalizers are aimed to invert a channel's frequency response for reduction of the intersymbol interference (ISI).

Equalization may be pre-emphasis, i.e., adapting the signal on the transmitter side to the expected distortions, since in some embodiments, information may be received on the transmitting side from the receiving side, such that the properties of the communication channel are known and can be dynamically compensated for. Thus, pre-emphasis relates to emphasizing the desired properties, for example the high frequencies. In other embodiments, the correction may be predetermined without considering further information of the channel characteristics.

Additionally or alternatively, post-emphasis correction may be performed at the receiving side. Post emphasis equalization may use passive components which have low power consumption, and can operate with different bandwidths. Post emphasis equalization may provide better results, as it ensures that the output signal takes into consideration the actual distortions of the communication channel. In some embodiments, calibrating the post-emphasis equalizer may be performed by transmitting predetermined signals, checking the received signals and adapting the equalizer such that the received signal corresponds to the transmitted signal.

Some known types of equalization methods include:
Feed Forward Equalization (FFE) which modifies the amplitudes of the symbols in the transition regions, keeping the transmitted power constant;
Continuous Time Linear Equalization (CTLE) is applied at the receiver, attenuates low-frequency signal components and amplifies the components around the Nyquist frequency;
Decision Feedback Equalization (DFE) is implemented at the receiver and feeds the symbol decisions back to the symbol decoder.

In some embodiments, equalization may be performed using a Continuous Time Linear Equalization (CTLE). In some embodiments, the CTLE may be implemented using a Finite Impulse Response (FIR) filter, in which the impulse response, or the response to any finite length input, is of finite duration, since it settles to zero in finite time. Thus, the impulse response of an N^{th}-order discrete-time FIR filter lasts exactly N samples from the first through the last nonzero element before it settles to zero.

When implementing a FIR filter, the challenge is to select and implement the coefficients for each tap, such that the sum of the samples operated by the corresponding coefficients reproduces the transmitted signal.

### BRIEF SUMMARY

One exemplary embodiment of the disclosed subject matter is a method for improving transmission in an optical communication system, comprising: receiving an optical signal; using an optical equalization filter, equalizing the optical signal to obtain an equalized optical signal; converting the equalized optical signal to an electrical signal; comparing the electrical signal to an expected electrical signal to obtain a comparison result; based on the comparison result, determining one or more optical parameters to be modified for the optical equalization filter; based on the optical parameters to be modified, determining a modification to be applied to the optical equalization filter; and applying the modification to the optical equalization filter, thereby determining in an electrical domain distortions to the optical signal, and applying the changes in an optical domain for correcting distortions introduced to the optical signal. The method can further comprise repeating said receiving, equalizing, transforming, comparing, determining the optical parameters and the modification until a difference between the electrical signal and the expected electrical signal is below a predetermined threshold. Within the method, the optical signal is optionally received in a receiving side of the optical communication system, subsequent to the optical signal being carried by an optical fiber. Within the method, the optical signal is optionally received in a transmitting side of the optical communication system, wherein an optical signal corresponding to the equalized optical signal is being carried by an optical fiber to a receiving side. Within the method, each of the optical parameters to be modified affects at least one performance measure selected from the group consisting of bit error rate, symbol error rate, channel impulse response, eye-opening, eye width, eye height, signal rise and fall time, signal-to-noise ratio, and extinction ratio. Within the method, the modification is optionally selected from the group consisting of: changing the temperature of a thermo-optic phase shifter and applying a reverse bias to a PN depletion phase shifter. Within the method, the modification is optionally performed by changing one or more characteristics of the optical equalization filter, selected from the group consisting of: a delay line, a phase shifter and a coupler. Within the method, said comparing or said modification determination are optionally performed using non-invasive components. Within the method, said comparing or said modification determination are optionally performed using one or more methods selected from the group consisting of Least mean Squares (LMS), Gauss-Newton, Levenberg-Marquardt, Neural Networks, Deep Neural Networks, and Reinforcement Learning.

Another exemplary embodiment of the disclosed subject matter is an apparatus for improving transmission in an optical communication system, comprising: an optical equalization filter for receiving an optical signal and outputting an equalized optical signal; an optical to electrical converter for receiving the equalized optical signal and outputting an electrical signal; a digital signal processor (DSP) for comparing the electrical signal to an expected electrical signal, and determining a change to an optical parameter of the optical equalization filter; and a controller for applying a modification to the optical equalization filter for achieving the change, wherein the apparatus is thereby operative for determining distortions to the optical signal in an electrical domain, and applying the changes in an optical domain for correcting distortions introduced to the optical signal. Within the apparatus, the controller is optionally a micro controller unit (MCU). The apparatus is optionally positioned at a receiving side of the optical communication system and receives an optical signal carried by an optical fiber. Within the apparatus, the optical signal is optionally received in a transmitting side of the optical communication system, wherein an optical signal corresponding to the equalized optical signal is optionally being carried by an optical fiber to a receiving side. Within the apparatus, an optical parameter to be modified optionally affects one or more items selected from the group consisting of: bit error rate, symbol error rate, channel impulse response, eye-opening, eye width, eye height, signal rise and fall time, signal-to-noise ratio, and extinction ratio. Within the apparatus, the modification is optionally selected from the group consisting of: changing the temperature of a thermo-optic phase shifter and applying a reverse bias to a PN depletion phase shifter. Within the apparatus, the modification performed by changing a characteristic of the optical equalization filter, is optionally selected from the group consisting of a delay line, a phase shifter and a coupler. Within the apparatus, the comparing or the modification determination are optionally performed using non-invasive components. Within the apparatus, the comparing or the modification determination are optionally performed using at least one method selected from the group consisting of: Least mean Squares (LMS), Gauss-Newton, Neural Networks, Deep Neural Networks, and Reinforcement Learning.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a schematic illustration of a first embodiment of an optical communication system, in accordance with some exemplary embodiments of the disclosure;

FIG. 1B is a schematic illustration of a second embodiment of an optical communication system, in accordance with some exemplary embodiments of the disclosure;

FIG. 1C is a flowchart of steps in a method for improving equalization in an optical communication system, in accordance with some exemplary embodiments of the disclosure;

FIG. 2 is a frequency response graph of a continuous time linear equalizer (CTLE), in accordance with some exemplary embodiments of the disclosure;

FIG. 3 is a schematic illustration of the general structure of a finite impulse response (FIR) filter, in accordance with some exemplary embodiments of the disclosure;

FIG. 4 is a pictorial illustration of an optical FIR filter in the frequency domain, in accordance with some exemplary embodiments of the disclosure;

FIG. 5 is a schematic illustration of an exemplary embodiment of a two-stage filter, in accordance with some exemplary embodiments of the disclosure;

FIG. 6A is a schematic illustration of a photonic integrated circuit, in accordance with some exemplary embodiments of the disclosure;

FIG. 6B and FIG. 6C show, respectively, schematic illustrations of 2-tap and 4-tap filters, in accordance with some exemplary embodiments of the disclosure; and

FIGS. 7A-7C show simulated results of applying the disclosure to an optical communication system, in accordance with some exemplary embodiments of the disclosure.

### DETAILED DESCRIPTION

One technical problem handled by the disclosure is the need to improve the quality of a signal received on the receiving side of a network where the signal is transmitted as light pulses through an optical medium.

Another technical problem of the disclosure is the need for enhancing the signal in post-emphasis manner, i.e., on the receiving side, for example by using a post-emphasis equalizer.

Yet another technical problem of the disclosure is the need for enhancing the signal using passive components which are more energetically and time efficient. However, due to the dynamic nature of the communication channel, the equalization needs to be adaptable to the changing conditions. For example, the equalizer may need to be calibrated every predetermined period of time such as one milliseconds, one second, one minute, ten minutes, one hour, one day, one month, or the like. Calibration may be performed by transmitting a predetermined signal, such as a predetermined sequence of ones and zeros, receiving the signal on the receiving side and enhancing the equalizer such that the obtained signal is the same as the transmitted one, or within an acceptable range of errors.

One technical solution of the disclosure comprises equalizing the signal using a post-emphasis photonic device as a filter which operates in the optical domain, and adapts the optical signal according to the required response function. Unlike current techniques, in which the correction is performed in the digital domain, making the correction in the optical domain provides for using passive components which are energetically efficient, reduce latency and provide high performance.

The filter may consist of or comprise a finite impulse response (FIR) filter having a predetermined number N of tap filters. The FIR filter operates such that each sample of the N samples is operated upon using a coefficient (the operation referred to as a stage), and the N stages are summed.

In some embodiments, each such stage or combination of two or more stages may be generated by a combination of components, including a coupler, a delay line, and a phase shifter. Two light conducting elements go through the components, such that the input light is split between the two waveguiding elements.

The length difference between the waveguides in the delay line determines the Bandwidth of the filter.

At least two of the other components may have thereon a heatable element, for example an electrically conducting element that heats when an electric signal passes through it. Heating the heatable element of the coupler may affect the coupling between the two conductors, and heating the heatable element of the phase shifter may affect the phase difference between the two light conducting elements.

Changing the phase difference and the coupling may enhance the received signal, such that the output light signal optimally reproduces the input signal, or is within an acceptable error rate. If the input signal is an electric signal, in order to reconstruct the enhanced light signal may be input into a photodiode that will produce an output electric signal which is equal to the input signal in response to absorbing the photons.

In some embodiments, a filter may be designed to implement one, two, or more stages, by comprising a plurality of delay lines, couplers or phase shifters, and which outputs a sum of two or more products.

One technical effect of the disclosure relates to an equalizer filter, implemented as a photonic device operated in the optical domain on the receiving side of an optical communication network. The equalizer comprises passive components, therefore it provides low latency. Additionally, the passive components eliminate the need of complex computations, and thus reduce the energy requirements of the system.

Another technical effect of the disclosure relates to the filter being adjustable, such that it can be fine-tuned according to the possibly changing conditions of the communication channel or changing characteristics of the input signal.

Linear equalizers cannot distinguish between signal, noise and cross-talk. Thus, linear equalizers can improve the intersymbol interference, while the Signal to Noise Ratio (SNR) remains unchanged. In optical links the main source of the noise is relative intensity noise related to the lasers and modulators (e.g., electro absorption modulators). The noise power is directly related to the bandwidth of the optical signal. If equalization is implemented after the light is provided to the photodiode, the photodiode is open to many frequency ranges and inserts a lot of noise which needs to be handled. Equalizing before the photodiode by implementing filters in the optical domain is useful in controlling the optical bandwidth and improving the SNR in the receiver. Thus, while digital equalizers improve the intersymbol interference but not the SNR, using the current disclosure provides for improving both. In addition, equalization in the optical domain may significantly reduce the latency and the power requirements associated with signal processing in the digital domain.

Yet another technical effect of the disclosure relates to applying the filter with any equalization method, such as but not limited to DFE, FFE and CTLE.

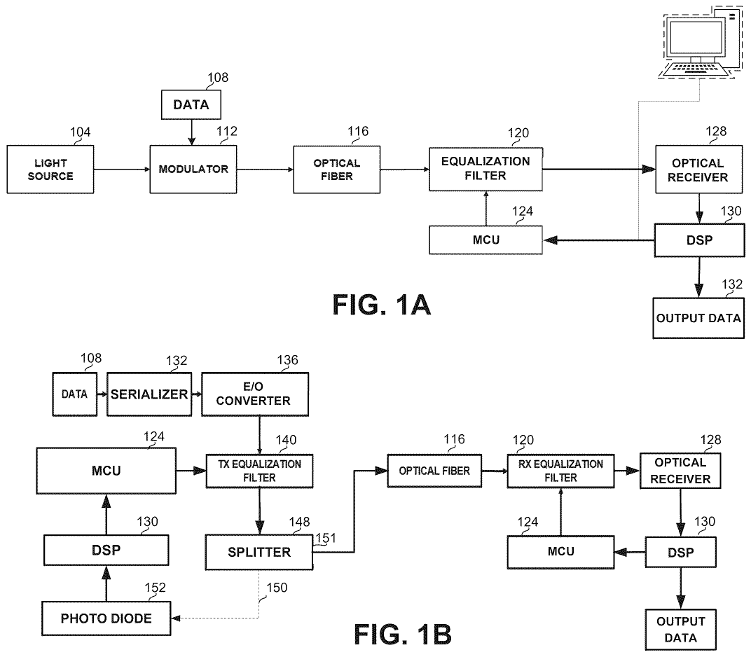

Referring now to FIG. 1A, showing a schematic illustration of a first embodiment of an optical communication system in which the current disclosure may be implemented.

The system comprises a light source 104, such as a laser light source. Modulator 112, which converts from electrical signal to optical signal, may modulate the light source in accordance with digital data 108. Depending on the parameter of the light beam which is manipulated, modulator 112 may comprise one or more amplitude modulator, phase modulator, and/or polarization modulator. In some embodiments, instead of external modulation performed by light modulator 112, the current driving the light source, e.g., a laser diode, may be manipulated in order to modulate a light beam, referred to as direct modulation.

The modulated light is transmitted through an optical fiber 116, to the destination. Optical fiber 116 may be of any required length, for anon-limiting example between 1 m and 10 km. Although it is considered highly efficient and reliable, optical fiber 116 may introduce noise, losses and other distortions.

Equalization filter 120 may be an optical equalization filter, and may be used for correcting the various distortions of the optical communication system as detailed below. The coefficients of equalization filter 120 may be updated by Micro Controller Unit (MCU) 124, in response to changes in the characteristics of optical communication channel comprising components 112, 116, 120 and optical receiver 128. For example, equalization filter 120 may be updated dynamically when the errors introduced by the optical communication channel comprising components 112, 116, 120 and 128 to a known predetermined signal exceed an allowable rate. The coefficients may change the behavior of the delay line, the phase shifter and the directional coupler.

The equalized signal may be provided to optical receiver 128, such as one or more photodiodes, for obtaining an electric signal 108.

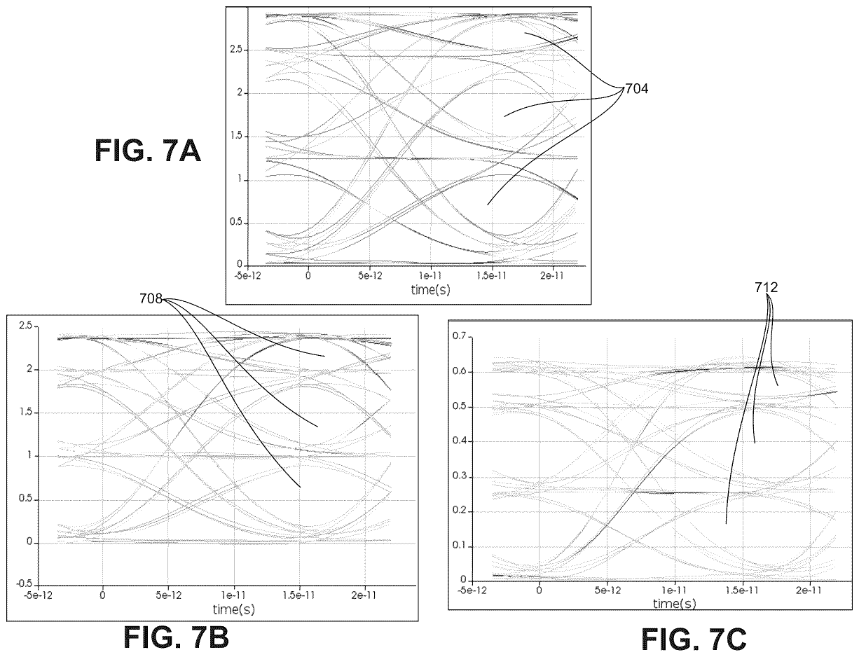

The electrical signal may be provided to digital signal processor (DSP) 130, for analyzing and enhancing the signal, for example by comparing the received signal to a known transmitted signal. The signal may be analyzed for the signal quality, level separation as detailed in association with FIGS. 7A-7C, or the like. Analysis of the signal may comprise executing algorithms for determining the updated filter coefficients required for compensating for the distortions.

Once the changes to the equalization filter are determined, a controller such as a micro controller unit (MCU) 124 may be operative in making the required modifications to equalization filter 120, for example updating one or more of the coefficients of equalization filter 120, that would affect its behavior and thereby correct the distortions.

In some embodiments, optical receiver 128 and DSP 130, or DSP 130 and MCU 124 may be implemented as a single component. Additionally or alternatively, DSP 130 maty comprise a deserializer.

The resulting signal may be output as output data 132 which reproduces data 108, up to a certain bit error rate (BER). For example, an acceptable BER may be in the range of 10⁻³-10⁻¹⁵ or the like.

Referring now to FIG. 1B, showing a second embodiment of an optical communication system, in which the current disclosure may be implemented.

The system of FIG. 1B receives as input digital data 108, which may be serialized by serializer 132 to convert it into a series of electric pulses.

The series of pulses may be converted by electrical optical (E/O) converter 136 into a series of light pulses.

If the distortions introduced by Optical communication channel comprising components 112, 116,120 and 128 are known, the light pulse series may be enhanced by transmitter equalization filter 140 in accordance with the known distortions. Transmitter equalization filter 140 may be modified as necessary, according to the changing distortions, by using updated filter coefficients. The modification may be dynamic, periodical, or the like.

The optical signal may be provided to splitter 148, that splits the energy of the optical signal. Splitter 148 may be a non-symmetric splitter, for example it may split most of the energy 151, such as 80%, 90%, 95%, 99% or the like, to optical fiber 116, and the rest of the energy, such as 20%, 10%, 5%, 1% or the like back as feedback. The smaller part 150 of the energy may be provided to photodiode 152 or another optical to electrical converter. The resulting signal may be provided to DSP 130 and MCU 124 as above, which would correct the distortions of transmitted equalization filter 140.

The major part 151 of the energy may then be transmitted via optical fiber 116 and as in FIG. 1A above, enhanced by receiver equalization filter 120 which may be modified in accordance with updated filter coefficients as above. The enhanced signal may be converted into electrical data by optical receiver converter 128, and processed by DSP 130, and the processing results may be used in updated filter coefficients 124, and output as data output 132, which reproduces data 108, up to a certain bit error rate (BER). For example, an acceptable BER may be in the range of 10⁻³, −10⁻¹⁵ or the like.

It is appreciated that receiver equalization filter 120 may be used in addition to or alternatively to transmitter equalization filter 140. Thus, the signal may be enhanced before and/or after being transmitted via optical fiber 116.

The disclosure, as described in but not limited to the disclosed embodiments, provides for closing a feedback loop such that the distortions are detected in the electrical domain, but are fixed in the optical domain, by adapting the parameters of the optical equalization filter. Additionally, the equalizing filter can limit the frequency bandwidth to reduce the power of noisier frequencies launched to the photodetector, thereby enhancing the required frequencies and reducing the noise. Fixing the distortions in the optical domain provides for faster response time, as the latency depends on the time it takes light to traverse the system, which is negligible. Additionally, fixing in the optical domain eliminates the need to fix in the electrical domain, thereby reducing the energy consumption and the cooling requirements of the electronic components.

Referring now to FIG. 1C, showing a flowchart of steps in a method for improving equalization in an optical communication system, in accordance with some exemplary embodiments of the disclosure.

On step 160, an optical signal may be received, whether on the transmitting side of the communication system for example by transmitter equalization filter 140, or on the receiving side of the communication system for example by receiver equalization filter 120.

On step 164, the optical signal may be equalized using an optical equalization filter, to obtain an equalized optical signal, for example by transmitter equalization filter 140 or receiver equalization filter 120.

On step 168, the equalized optical signal may be converted into an electrical signal, for example by optical receiver 128, photodiode 152 or the like.

On step 172, the electrical signal may be compared to an expected electrical signal to obtain a comparison result.

On step 176, based on the comparison results, one or more optical parameters may be determined to be modified for the optical equalization filter. Comparison step 172 and parameter determination step 176 may be performed by DSP 130. The parameters may include but are not limited to any one of more of the following performance measures: bit error rate, symbol error rate, channel impulse response, eye-opening, eye width, eye height, signal rise and fall time, signal-to-noise ratio, extinction ratio, or the like. The “eye” parameters are further detailed in association with FIGS. 7A-7C below.

The filter is initially designed to implement the required transfer function. The FIR filter may be characterized by a specific number of taps, where each tap is associated with a filter coefficient value. The impulse response of the FIR filter corresponds to the collection of the filter coefficients values.

The length difference (ΔL) within the phase shifting elements of the filter may be calculated based on the following formula:

$$FSR = \frac{{λ}^{2}}{Δ L \cdot {n}_{g} ( λ )}$$

wherein FSR is the free spectral range which determines the bandwidth of the optical filter, λ is the wavelength and n_{g}(λ) is a waveguide group refractive index.

The coefficient values may be transformed into optical delay lines, directional couplers and phase shifters.

The directional couplers may be realized as Mach Zehnder interferometer (MZI) and hence implemented as a cascade of fixed 3 dB couplers acting as a splitter, a phase shifter and a second 3 dB coupler acting as a combiner.

The design of the FIR filter may involve the use of one or more algorithms or techniques to estimate the channel response and determine the appropriate filter coefficients. These methods may include but are not limited to least mean squares (LMS), Gauss-Newton, Levenberg-Marquardt, minimum mean square error (MMSE), maximum likelihood estimation and Neural Networks (NN).

Then, on step 176, the parameter determination may be performed.

The phase shift within the variable directional coupler

Two parameters may be defined: θₙ and φₙ.

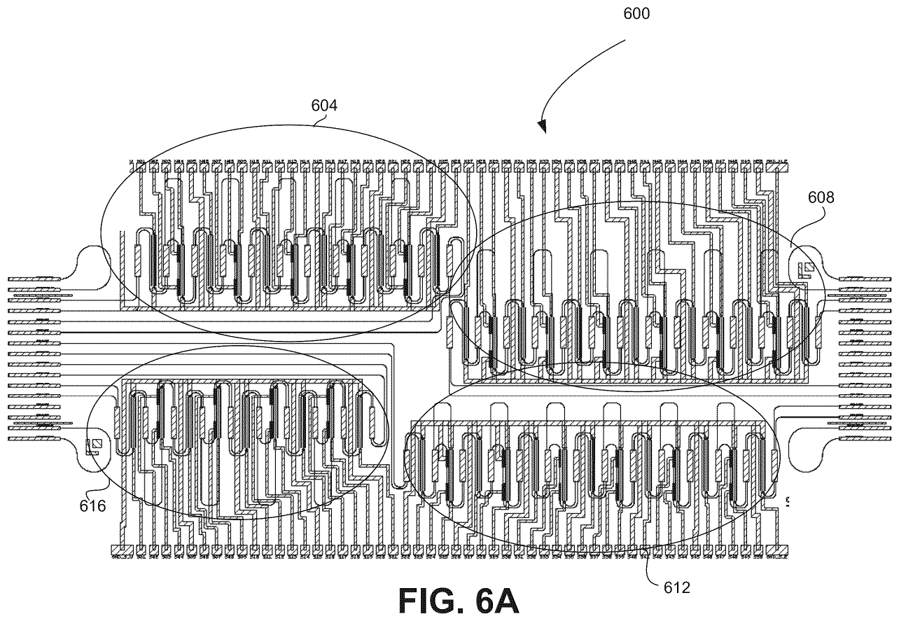

θₙ is the normalized phase shift caused by the length difference of the two arms in each variable directional element (see below variable directional couplers 504, 512, 520 of FIG. 5) and the effect of the electrical power applied to the heater in one of the arms. Further phase shift is cause by the variable directional couplers which can be regarded as a delay line with zero path length difference. Since heating changes the phase, the directional coupling changes as well. Thus, θₙ represents the variable directional coupling where the arms (501, 502) are theoretically of the same length but practically may exhibit some difference. φₙ on the other hand, represents the directional coupling in the components with the significant arm difference (508 516).

For low heater powers θₙ depends linearly on power dissipation. For more significant heater powers, it is found that the phase change depends quadratically on the applied power. (the coefficient will be obtained as fitting parameters as part of the device characterization).

φₙ is the modulo 2π part of the phase shift caused by the length difference, plus the phase shift introduced by heating one of the arms. Common algorithms for determining the values of θₙ and φₙ comprise the Least Mean Squares, Gauss-Newton, Levenberg-Marquardt, Neural Networks (NN), Deep Neural Networks, or other Machine Learning algorithms related to the optimization problems. The calculated phase parameters θₙ and ωₙ are then used as starting values for a nonlinear optimization using the real device model, such that θₙ and φₙ are translated into heater power.

For faster convergence, non-invasive measurement are enabled by adding heatable elements on the short arms of the phase shifting elements for determining the phase shift. The result is aimed at providing parameters that fit the real device model response to the desired spectrum.

On step 180, based on the optical parameters to be modified, a modification to be applied to the optical equalization filter may be determined. The modification may include changing the temperature of a thermo-optic phase shifter or applying a reverse bias to a PN depletion phase shifter. To achieve equalization, the received signal is processed through the Finite Impulse Response (FIR) filter. The FIR filter convolves the received signal with its coefficients to obtain θₙ and φₙ and thus the heater power, thereby effectively adjusting the frequency characteristics to compensate for the channel's distortions and attenuations.

On step 184 the modification may be applied the optical equalization filter in order to modify its behavior and compensate for the distortions. Determining the modification step and applying the modification step may be performed by MCU 124. The possible modifications may include but are not limited to any one of more of the following: changing the temperature of a thermo-optic phase shifter, applying a reverse bias to the PN depletion phase shifter, or the like.

It is appreciated that the desired performance may not be obtained by one iteration as described above. Thus, the process may be repeated and restart at step 160 one or more times until the performance, e.g., the BER is within the acceptable range.

Moreover, the channel characteristics may change over time which may lead to undesired degradation in the performance, thus the feedback and equalization adaptation may need to be repeated continuously or at least periodically.

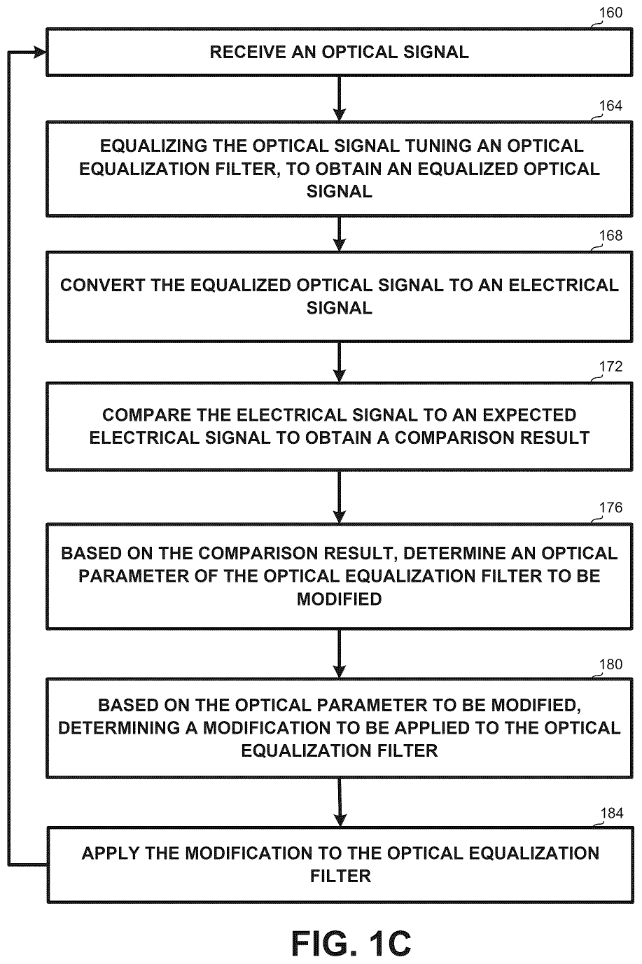

Referring now to FIG. 2, showing a frequency response graph of a CTLE, in accordance with some exemplary embodiments of the disclosure.

By applying post equalization, i.e., equalization after the light pulses have been transmitted through the optical channel, the transfer function of the equalized channel, i.e., the product of the transfer functions of the channel and CTLE, becomes flat over a wider frequency range. Thus, by placing the CTLE in series with the channel, the equalizer selectively decreases gain in the low frequencies (for example by a factor of −5 to −10) but maintains the gain for the high frequencies, thereby improving the quality of the received signal.

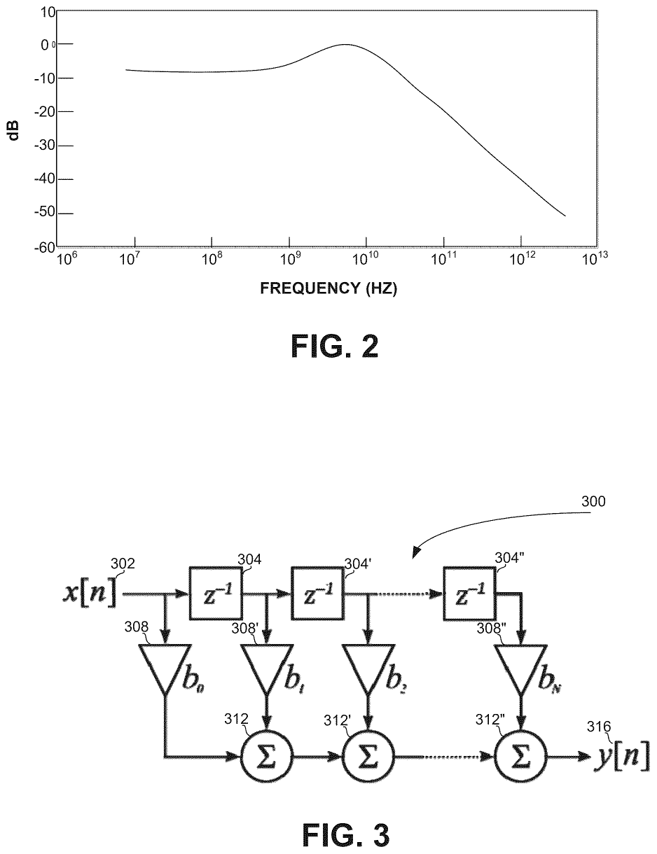

Referring now to FIG. 3, showing a schematic illustration of the general structure of a FIR filter implementing a CTLE, in accordance with some exemplary embodiments of the disclosure.

The FIR filter, generally referenced 300, receives as input a discrete input signal x[n], and outputs y[n], according to the formula:

$$y [ n ] = {\sum }_{i = 1}^{n} {b}_{i} x [ n - i ]$$

wherein:
n is the order of the filter;
x[n](302) is the current sample;
Z⁻¹ (304, 304′, 304″) are the unit delay operators;
bᵢ (308, 308′, 308″) are the coefficient combinations to be applied to the respective delayed sample;
the Σ operators (312, 312′, 312″) sum their respective inputs; and
y[n](316) is the output sample obtained in n unit delay after x[n] is received.

In order to obtain a satisfactory output signal, it is required to adjust the bᵢ coefficients 308, 308′, 308″, to be applied to the relevant delayed signal, such as to compensate for the distortions introduced by the optical fiber.

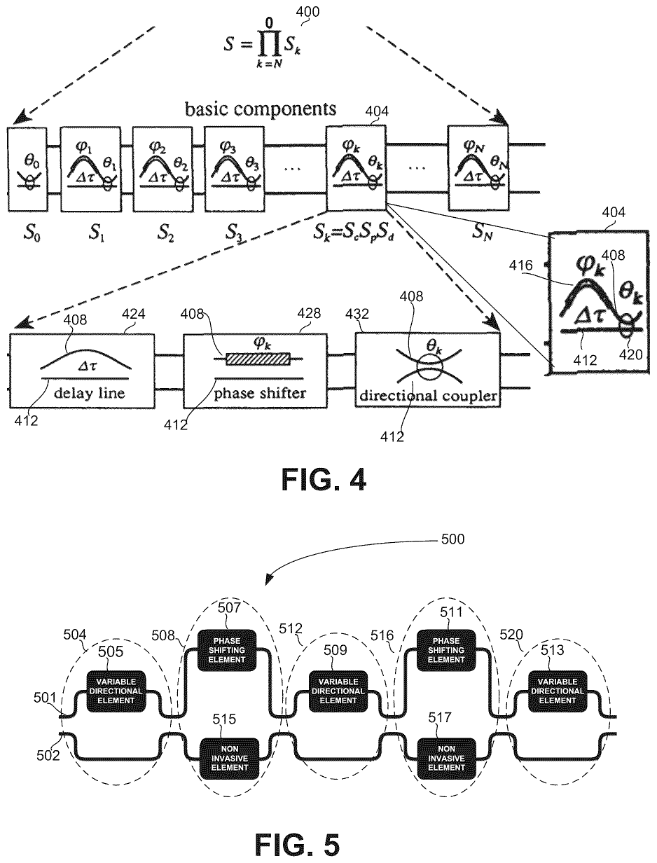

Referring now to FIG. 4, showing an illustration of an optical FIR filter in the frequency domain, implementing an equalization filter, in accordance with some exemplary embodiments of the disclosure.

The filter, generally reference 400, comprises N components, each component denoted Sₖ 404 is equivalent to a relevant bᵢ to be applied to the x[n] input with the corresponding delay. Sₖ 404 is a combination of three factors: a delay line, a phase shift and directional decoupling.

The components are implemented by two optical waveguides 408 and 412. The light may be split between the two waveguides, and the interrelations therebetween may determine these factors.

Thus, the length difference between lines 408 and 412, as shown in pane 424 determines the delay Δτ.

One of the waveguides, for example waveguide 408 may have attached thereto a heating element 416, which changes the phase φₖ of the light that passes through conductor 408 relatively to the original phase as passes through conductor 412, as shown in pane 428.

The distance and structure combination of waveguides 408 and 412 and in particular in area 420 where they are closest to each other, determine the directional coupling θₖ between the conductors as shown in pane 432. By placing another heatable element (not shown) on one of the conductors in area 420, the coupling may also change.

Thus, by changing the temperature of heating element 416 and/or the other heating element, the phase and the coupling between the light conductors may change, thereby changing the specific bᵢ and therefore the signal. By injecting a predetermined signal and adapting the bᵢ's by changing the temperature of the heating elements until the output signal corresponds to the input signal, the system may be dynamically adapted to provide appropriate post emphasis equalization.

In some embodiments, a multi-mode interferometers (MMI) coupler can be used instead of a directional coupler.

Referring now to FIG. 5, showing a schematic illustration of an exemplary embodiment of a two-stage FIR filter, in accordance with some exemplary embodiments of the disclosure.

The filter referenced 500, comprises conductors 501 and 502, is arranged to comprise three variable directional couplers such as 504, 512 and 520, such that coupler 504 is responsible for θ₀, coupler 512 is responsible for θ₁ and coupler 520 is responsible for θ₂.

Filter 500 further comprises delay line and phase shifter 508, including phase shifting element 507. Delay line and phase shifter 508 is responsible for the phase shifting φ, and delay line and phase shifter 516 is responsible for the delay Δτ. Thus, the combination of the three couplers 504, 512 and 520, and delay line and phase shifters 508 and 516 provide for two combined stages of the FIR filter. Each of these elements comprises a conductive member, such as elements 505, 509 and 513 of couplers 504, 512 and 520 respectively, elements 507 and 511 of delay line and phase shifters 508 and 516. Each of conductive members 505, 507, 509, 511 and 513 is heated in response to current, thereby changing the coupling, the delay and/or the phase of the filter, such that the filter can be adjusted according to the changing conditions of the communication channel and equalize the output signal.

In some embodiments, conductor 502 may also comprise additional elements, such as elements 515 and 517 comprised in delay line and phase shifters 508 and 516, respectively.

Elements 515 and 517 may enable non-invasive measuring and determining modifications to be applied to the optical equalization filters. The non-invasiveness may enable faster convergence to the required signal. The determination of the parameter modification may be performed using any known method such as but not limited to Least mean Squares (LMS), Gauss-Newton, Levenberg-Marquardt, or the like. The modifications may also be determined using Neural Networks, such as Convolutional Neural Networks (CNN), Deep Neural Networks (DNN), or others.

It is appreciated that further filters may be designed, which comprise more couplers and optionally additional components, and thus implement a filter having a larger number of stages.

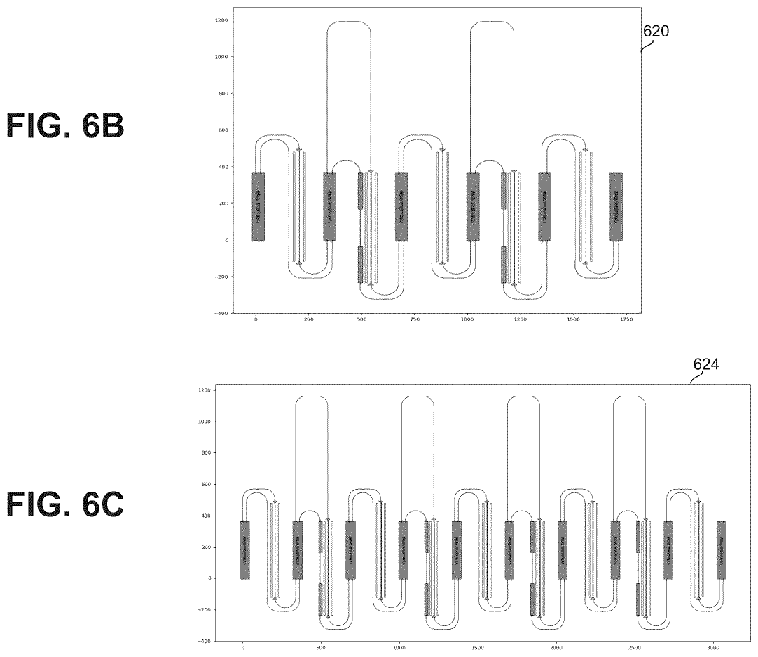

Referring now to FIG. 6A, showing a schematic illustration of a photonic integrated circuit comprising four filters, in accordance with some exemplary embodiments of the disclosure.

Thus, chip 600 comprises 5-tap filter 604, 6-tap filters 608 and 612, and 4-tap filter 616. Chip 600 has been implemented on Silicon Nitride; however, it can also be applied in other technologies, such as but not limited to Silicon and Silicon Germanium technologies.

FIGS. 6B and 6C show schematic illustrations of 2-tap filter 620 and 4-tap filter 624, respectively, in accordance with some exemplary embodiments of the disclosure.

Referring now to FIGS. 7A-7C, showing simulated results of applying the disclosure to an optical communication system, in accordance with some exemplary embodiments of the disclosure.

FIGS. 7A-7C show diagrams of the received signals in an optical communication network. Each of the diagrams may be referred to as an “eye” diagram, which is an oscilloscope display in which a digital signal is repetitively sampled and applied to the vertical input (y-axis), while the data rate is used to trigger the horizontal sweep (x-axis). In some situations, the pattern looks like a series of eyes between a pair of rails, and may be used for evaluation of the combined effects of the channel noise, dispersion and intersymbol interference on the performance of a baseband pulse-transmission system. From a mathematical perspective, an eye pattern is a visualization of the probability density function (PDF) of the signal, modulo the unit interval (UI). It is appreciated that larger empty areas (the “eyes”) indicate smaller distortions and a better signal with better separation between signal voltage levels.

FIG. 7A shows a four-level received signal without post-emphasis equalization, having openings (“eyes”) 704.

FIG. 7B shows the received signal after applying an electrical filter, following a trans impedance amplifier applied to the signal after the optical electrical conversion, and having openings 708.

FIG. 7C shows the signal after applying an optical FIR filter, in accordance with the disclosure, having openings 712. It is seen that openings 712 are larger than openings 704 and even larger than openings 708. Thus, it is clear that applying and adjusting the optical filter improves the equalization and thus the performance of the whole communication network, in addition to providing low latency and energetic efficiency.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, such as “C”, C#, C++, Java, Phyton, Smalltalk, or others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for improving transmission in an optical communication system, comprising:
receiving an optical signal;
using an optical equalization filter, equalizing the optical signal to obtain an equalized optical signal;
converting the equalized optical signal to an electrical signal;
comparing the electrical signal to an expected electrical signal to obtain a comparison result;
based on the comparison result, determining at least one optical parameter to be modified for the optical equalization filter;
based on the at least one optical parameter to be modified, determining a modification to be applied to the optical equalization filter; and
applying the modification to the optical equalization filter,
thereby determining in an electrical domain distortions to the optical signal, and applying the changes in an optical domain for correcting distortions introduced to the optical signal.

2. The method of claim 1, further comprising repeating said receiving, equalizing, transforming, comparing, determining the at least one optical parameter and the modification until a difference between the electrical signal and the expected electrical signal is below a predetermined threshold.

3. The method of claim 1, wherein the optical signal is received in a receiving side of the optical communication system, subsequent to the optical signal being carried by an optical fiber.

4. The method of claim 1, wherein the optical signal is received in a transmitting side of the optical communication system, wherein an optical signal corresponding to the equalized optical signal is being carried by an optical fiber to a receiving side.

5. The method of claim 1, wherein the at least one optical parameter to be modified affects at least one performance measure selected from the group consisting of: bit error rate, symbol error rate, channel impulse response, eye-opening, eye width, eye height, signal rise and fall time, signal-to-noise ratio, and extinction ratio.

6. The method of claim 1, wherein the modification is selected from the group consisting of: changing the temperature of a thermo-optic phase shifter and applying a reverse bias to a PN depletion phase shifter.

7. The method of claim 1, wherein the modification is performed by changing at least one characteristic of the optical equalization filter, the at least one characteristic selected from the group consisting of: a delay line, a phase shifter and a coupler.

8. The method of claim 1, wherein said comparing or said modification determination are performed using non-invasive components.

9. The method of claim 1, wherein said comparing or said modification determination are performed using at least one method selected from the group consisting of Least mean Squares (LMS), Gauss-Newton, Neural Networks, Deep Neural Networks, and Reinforcement Learning.

10. An apparatus for improving transmission in an optical communication system, comprising:
an optical equalization filter for receiving an optical signal and outputting an equalized optical signal;
an optical to electrical converter for receiving the equalized optical signal and outputting an electrical signal;
a digital signal processor (DSP) for comparing the electrical signal to an expected electrical signal, and determining a change to at least one optical parameter of the optical equalization filter; and
a controller for applying a modification to the optical equalization filter for achieving the change,
wherein the apparatus is thereby operative for determining distortions to the optical signal in an electrical domain, and applying the changes in an optical domain for correcting distortions introduced to the optical signal.

11. The apparatus of claim 10, wherein the controller is a micro controller unit (MCU).

12. The apparatus of claim 10, wherein the apparatus is positioned at a receiving side of the optical communication system and receives an optical signal carried by an optical fiber.

13. The apparatus of claim 10, wherein the optical signal is received in a transmitting side of the optical communication system, wherein an optical signal corresponding to the equalized optical signal is being carried by an optical fiber to a receiving side.

14. The apparatus of claim 10, wherein the at least one optical parameter to be modified affects at least one performance measure selected from the group consisting of: bit error rate, symbol error rate, channel impulse response, eye-opening, eye width, eye height, signal rise and fall time, signal-to-noise ratio, and extinction ratio.

15. The apparatus of claim 10, wherein the modification is selected from the group consisting of: changing the temperature of a thermo-optic phase shifter and applying a reverse bias to a PN depletion phase shifter.

16. The apparatus of claim 10, wherein the modification is performed by changing at least one characteristic of the optical equalization filter, the at least one characteristic selected from the group consisting of a delay line, a phase shifter and a coupler.

17. The apparatus of claim 10, wherein the comparing or the modification determination are performed using non-invasive components.

18. The apparatus of claim 10, wherein the comparing or the modification determination are performed using at least one method selected from the group consisting of: Least mean Squares (LMS), Gauss-Newton, Neural Networks, Deep Neural Networks, and Reinforcement Learning.
